(19) United States
(12) Patent Application Publication
(10) Pub. No.: US 2011/0310955 A1
(43) Pub. Date: Dec. 22, 2011

(54) METHOD AND SYSTEM FOR REPETITION BASED ADAPTIVE VIDEO COMPRESSION

(76) Inventor: Lei Zhang, San Jose, CA (US)

(21) Appl. No.: 12/986,752

(22) Filed: Jan. 7, 2011

Related U.S. Application Data
(60) Provisional application No. 61/357,352, filed on Jun. 22, 2010.
(60) Provisional application No. 61/421,988, filed on Dec. 10, 2010.

(51) Int. Cl. H04N 7/26

(52) U.S. Cl. 375/240.02; 375/E07.126

(57) ABSTRACT

A video transmitter may perform adaptive video compression, by comparing uncompressed picture data for a picture among a sequence of pictures with uncompressed picture data for one or more preceding pictures among the sequence of pictures, to detect presence of repeated data. The video transmitter may allocate based on presence of repeated data, a target bit count corresponding to the picture, wherein the target bit count may be used in generating compressed data corresponding to the picture within a compressed bitstream that is used for communication of said sequence of pictures. The allocation of the target bit count comprises determining at least a portion of the target bit count based on combining of encoding of repeated data between the picture and at least one proceeding also comprising the repeated data. The video transmitter may determine a number of repeated pictures for comparison, based on allowable transmission latency for example.

### CROSS-REFERENCE TO RELATED APPLICATIONS/INCORPORATION BY REFERENCE

This application makes reference to, claims priority to and claims benefit from U.S. Provisional Application Ser. No. 61/357,352, which was filed Jun. 22, 2010, and U.S. Provisional Application Ser. No. 61/421,988, which was filed on Dec. 10, 2010. Each of the above stated applications is hereby incorporated herein by reference in its entirety.

### FIELD OF THE INVENTION

Certain embodiments of the invention relate to video processing. More specifically, certain embodiments of the invention relate to a method and system for repetition based adaptive video compression.

### BACKGROUND OF THE INVENTION

Video data is typically compressed when being transmitted via a communication channel with limited bandwidth, for example, a wireless communication channel. Video data typically comprises a sequence of frames. A frame may also be referred to as a picture. Each frame typically comprises a plurality of picture elements, or pixels, arranged in a 2-dimensional array represented by a plurality of rows and a plurality of columns. The time interval between frames in the frame sequence is determined based on a frame rate. The time interval between frames, or frame time, is determined based on the inverse of the frame rate. The quantity of compressed video data within each frame is based on the number of pixels in the frame and the number of bits allocated to each of the pixels.

The rate at which data may be transmitted via the communication channel may be determined and/or limited by the channel capacity, or channel bandwidth, for the communication channel. The channel bandwidth for a communication channel is typically limited, typically based on the characteristics of and/or utilization of the communication medium. For example, a wireless communication medium may offer a lower channel bandwidth when compared to a wired communication medium.

Video compression enables video data from each frame to be transmitted within a frame time for a given channel bandwidth. Video compression may utilize various algorithms to receive original frame data, referred to as uncompressed video data, and generate compressed video data. Examples of video compression algorithms include JPEG-LS, MPEG, and/or AVC. The quantity of compressed video data is typically less than the quantity of uncompressed video data. The percentage reduction of video data is typically referred to as a compression ratio. A higher compression ratio corresponds to a greater reduction in the quantity of compressed video data in comparison to a lower compression ratio. Video compression algorithms may be lossy or lossless. Lossless video compression algorithms achieve video compression without loss of information contained within the original frame data. Lossy video compression algorithms may result in a loss of information that was contained in the original frame data. Lossy video compression algorithms typically have higher compression ratios in comparison to lossless video compression algorithms. Thus, the higher the compression ratio, the lower the bit rate for the compressed video data, and correspondingly, the lower the required channel bandwidth to communicate the compressed video data.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for repetition based adaptive video compression, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block chart that illustrates an exemplary system for repetition based adaptive video compression, in accordance with an embodiment of the invention.

FIG. 2A is a block chart that illustrates an exemplary transmitting device for repetition based adaptive video compression, in accordance with an embodiment of the invention.

FIG. 2B is a block chart that illustrates an exemplary receiver device for repetition based adaptive video compression, in accordance with an embodiment of the invention.

FIG. 3A is a flow chart that illustrates exemplary steps for adaptive video compression based on picture repetition during video transmission, in accordance with an embodiment of the invention.

FIG. 3B is a flow chart that illustrates exemplary steps for adaptive video compression based on slice repetition during video transmission, in accordance with an embodiment of the invention.

FIG. 4 is a flow chart that illustrates exemplary steps for receiving video data that may be compressed adaptively based on repetition, in accordance with an embodiment of the invention.

### DETAILED DESCRIPTION OF THE INVENTION

Certain embodiments of the invention may be found in a method and system for repetition based adaptive video compression. In various embodiments of the invention, repetition of data in a sequence of pictures may be detected. Based on the detection of repeated data, video compression may be performed adaptively such that the quantity of original frame data for each picture may be reduced variably during video compression operations based on available channel bandwidth and based on data repetition that are detected in a sequence of pictures. In this regard, larger number of bits compared to normal compression may be allocated to repeated data, to enhance resultant compressed bitstream. Various embodiments of the invention may enable the transmission of video data via a communication medium, which utilize lower compression ratios in comparison to some conventional systems. As a result of the lower compression ratio, in various embodiments of the invention, a larger quantity of bits may be allocated to encoding the original frame data for the compressed bitstream in comparison to some conventional systems. Furthermore, various embodiments of the invention may enable the transmission of higher quality images in comparison to some conventional systems since the larger quantity of bits may enable the transmission of higher resolution pictures. Consequently, in various embodiments of the invention, the bit rate for the compressed bitstream may be adaptively determined based on data repetition that may be detected in a sequence of pictures. Accordingly, various embodiments of the invention comprise a method and system for repetition based adaptive video compression. The transmission of a given adaptively compressed picture may be delayed until the number of repetitions of the picture is determined.

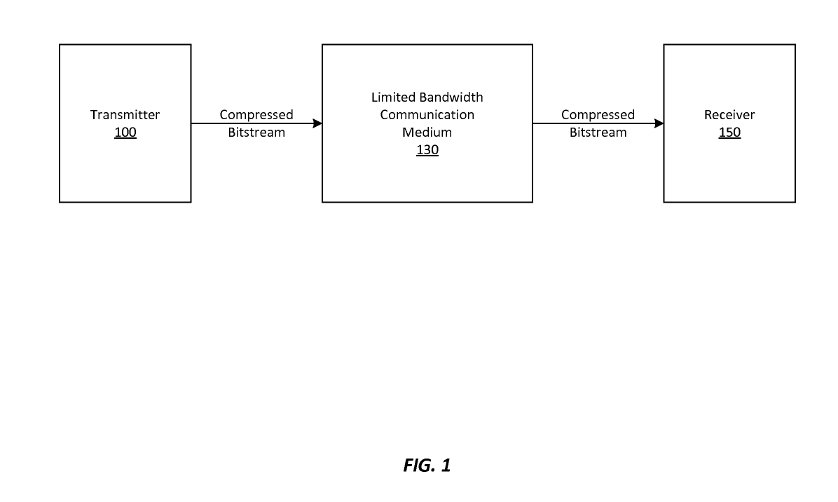

FIG. 1 is a block chart that illustrates an exemplary system for repetition based adaptive video compression, in accordance with an embodiment of the invention. Referring to FIG. 1, there is shown a video transmitter 100, a video receiver 150, and a communication medium 130. The video transmitter 100, video receiver 150, and communication medium 130 may each comprise suitable logic, circuitry, interfaces, and/or code, which may enable the operations and/or functionality described herein.

The video transmitter 100 may comprise suitable logic, circuitry, interfaces, and/or code that may be operable to generate a compressed bitstream, which may be communicated to the video receiver 150 via the communication medium 130 for example. The compressed bitstream may correspond to, for example, pictures and/or still images. For example, the video transmitter 100 may receive, generate, and/or capture uncompressed video data corresponding to a sequence of pictures, and may generate corresponding compressed bitstream for transmittal to the video receiver 150 for example. In this regard, the video transmitter 100 may be operable to generate the compressed bitstream from video data corresponding to the uncompressed pictures. The uncompressed pictures, and/or video data corresponding thereto, may be stored within, and accessed by the video transmitter 100.

The video receiver 150 may comprise suitable logic, interfaces circuitry and/or code that may be operable to receive a compressed bitstream, via the communication medium 130 for example. The video receiver 150 may be operable to decode the received compressed bitstream, to generate a sequence of decoded pictures which may then be displayed, directly and/or indirectly, via the video receiver 150. In this regard, the decoded pictures generated by the video receiver 150 based on decoding the received compressed bitstream may correspond to the original uncompressed pictures in the video transmitter 100 prior to compression by the video transmitter 100.

The communication medium 130 may comprise suitable logic, circuitry, interfaces, and/or code that may enable communication of data between different nodes and/or devices. In this regard, the communication medium 130 may facilitate communication of data, including compressed bit streams associated with video data for example, from the video transmitter 100 to the video receiver 150. The data communication via the communication medium 130 may be based on one or more wireless interfaces and/or standards. The communication medium 130 may comprise, for example, a wireless communication medium, which may enable wireless local area network (WLAN) based communications for example.

In operation, the video transmitter 100 may generate a compressed bitstream, based on a sequence of uncompressed pictures, and may communicate the compressed bitstream to the video receiver 150, via the communication medium 130 for example. In this regard, the video transmitter 100 may receive, generate, and/or capture the sequence of uncompressed pictures. The video transmitter 100 may generate the compressed bitstream from and/or based on video data corresponding to the uncompressed pictures in the sequence. The video receiver 150 may decode the received compressed bitstream, and may generate a sequence of decoded pictures for display. In this regard, the decoded pictures generated by the video receiver 150 may correspond to the original uncompressed pictures in the video transmitter 100. Generating the compressed bitstream, by the video transmitter 100, may be necessitated by bit rate limitations during data communication, such as in the communication medium 130, due to channel bandwidth limitations therein. The communication medium 130 may only be operable to provide, for example, communication channels with limited bandwidth to support communication between the video transmitter 100 and the video receiver 150. The limited channel bandwidth may not be sufficient to enable communicating the uncompressed pictures in timely manner. In this regard, communicating the pictures in uncompressed form may require a bit rate that may be greater than the maximum bit rate available in the communication medium 130. Accordingly, where the bandwidth required for communicating the uncompressed pictures exceeds the maximum available bandwidth of the communication medium 130, the video transmitter 100 may perform video compression such that the size of each compressed pictures, expressed in number of bits for example, may be reduced compared to the corresponding original uncompressed picture in the sequence. As a result, the data corresponding to the sequence of pictures may be compressed, such that the data rate (or bit rate) required for communicating the compressed bitstream, which is generated by the video transmitter 100, may conform to available bandwidth and/or bit rates of the communication medium 130. For example, in instances where each uncompressed picture in the sequence may comprise 5 megabits, and where the sequence of compressed pictures has frame rate of 1 frame per second, communicating the uncompressed pictured may require a bitrate of ˜5 mbps. Therefore, in instance where the maximum bandwidth available in the communication medium 130 is limited to, for example, 2.5 mbps, data compression at, for example, about 2-to-1 may be required to enable communication of the sequence of pictures via the communication medium 130 in timely manner.

In various embodiments of the invention, video compression in the video transmitter 100 may be performed adaptively, such that pictures, and/or portions thereof, may be allocated variable number of bits in the compressed bitstream corresponding to the sequence of pictures, to enable use of different compression ratios for some pictures, and/or portions in pictures. Decreasing compression ratio, which may be equivalent to ratio between compressed data and original uncompressed data, may be desirable because smaller compression ratios, such as between 1 and 2, may enable achieving lossless compression during the data communication. Accordingly, even where the compression ratio required for the sequence of picture as whole may fall outside desirable ranges, use of adaptive video compression may enable enhancing quality of the transmission by applying better compression ratios to only certain parts of the sequence, such as to some pictures and/or portions therein. In this regard, with fixed video compression, each picture in the sequence of pictures may be compressed based on, for example, predetermined per-picture bit count, which may be determined based on, for example, maximum available bit rate in the communication medium 130. Thus, while in fixed video compression each uncompressed picture would be allotted the same amount of bits in the compressed bitstream, and would be compressed as a whole regardless of any variations from and/or similarities to other pictures in the sequence, and/or with disregard to characteristics of different portions of the pictures; variable and/or adaptive based video compression may allow allocating variable number of bits to pictures or the portions thereof. This may be more desirable since it may allow freeing bits that may otherwise be utilized unnecessarily to encode the same data, such as where consecutive pictures comprise unchanged regions. Freeing such bits may in turn allow allocating additional bits in the compressed bitstream selectively and/or adaptively to pictures, or portions thereof, such that the compression ratio needed to ensure that the available channel bandwidth is not exceeded, may ultimately be reduced, and use of smaller compression ratios would generally allowing enhanced quality. In this regard, the video transmitter 100 may determine that it may be more desirable to enhance encoding of, for example, given pictures and/or certain portions of given pictures. The video transmitter 100 may adaptively allocate, where possible, more bits for encoding portions of given pictures comprising moving video compared to portion comprising textual or still video. Allocating additional bits may enable reducing the compression ratio since more bits would be utilized for encoding these portions. Furthermore, to accommodate allocating these additional bits, other portions and/or pictures may be allocated less bits, to ensure that the maximum per-picture bit allocation is not exceeded, resulting in increase in compression ratios for those other portions.

Adaptive video compression may be performed based on detection of repeated data in the sequence of the uncompressed pictures. The video transmitter 100 may analyze, for example, each of the pictures in the sequence of uncompressed pictures to detect repetition of data among and/or within the pictures in the sequence of uncompressed pictures. The video transmitter 100 may then utilize various video compression related algorithms and/or techniques to generate the compressed bitstream based on the available bandwidth in the communication medium 130 and based on the data repetition in a sequence of pictures. Accordingly, while the bit rate for the compressed bitstream as a whole may be maintained, to match the maximum available bit rate in the communication medium 130 for example, bit allocation within the compressed bitstream may be adaptively determined by the video transmitter 100 based on, for example, presence of repetition detected in each picture among the sequence of pictures. For example, because a given picture may be repeated, as a whole, multiple times in the sequence, data that may corresponds to the picture in the sequence of uncompressed pictures may span a plurality of frame time periods within the compressed bitstream. The number of frame time periods may be determined based on the number of repetitions in the sequence of uncompressed pictures, allowed transmission delay of the first repeated picture, and/or latency that may be incorporated into the transmission. In this regard, a user of the video transmitter 100 and/or the video receiver 150 may configure an acceptable latency when viewing the sequence of the pictures, wherein that latency may be translated to frame time periods that may be utilized during repetition detection operations. For example, where the picture is repeated three times in the sequence, that picture may be allocated a number of bits up to 3 frame times in the compressed bitstream for example, if the communication of the sequence allows for up to 3 frame times delay.

In various embodiments of the invention, the video transmitter 100 may adaptively perform video compression on portions of pictures based on detection of data repetition detected between collocated portions of pictures in the sequence of uncompressed pictures. The portion of the picture, referred to as a slice, may comprise a plurality of consecutive rows and/or columns, which are located within the picture. The video transmitter 100 may detect for each picture in the sequence, for example, presence of repeated data within each picture and unrepeated data compared to other pictures in the sequence. In this regard, repeat slices may correspond to, and/or may comprise the repeated data within a picture, and the non-repeat slices may correspond to, and/or may comprise the unrepeated data within the picture. Accordingly, in various embodiments of the invention, the video transmitter 100 may allocate bits in the compressed bitstream to, and/or may perform compression differently on repeat and non-repeat slices within given pictures. In this regard, the video transmitter 100 may determine that it may be more desirable to enhance encoding of one type of the slices, such as the non-repeat slice, even at the expense of the other slice. This may be achieved by reducing the compression ratio applicable to the non-repeat slice, allocating more bits for encoding the non-repeat slices, while allocating less bits to the repeat slice to ensure that the maximum per-picture bit allocation is not exceeded.

In an exemplary embodiment of the invention, after determining that given picture comprises repeat and non-repeated slices, the video transmitter 100 may adaptively allocate bits for compression of repeat slices based on data repetition that are detected among the repeat slices while allocating bits to the non-repeat slices based on the maximum available bit rate in the communication medium 130. For example, where available transmission bit rate may mandate a maximum of 500 bits per picture time during the communication, the video transmitter may allocate to the non-repeat slices in each picture time a portion of the 500 bits that may be proportional to the proportion of the non-repeat slice within the uncompressed pictures. Where the uncompressed picture comprises 1,000 bits, for example, and the non-repeat slice accounts for 40% of the uncompressed picture, the non-repeat slice may be allocated every picture time, 200 bits which is 40% of the per-picture maximum bit count. During video compression of the repeat slices, however, the video transmitter 100 may allocate bit count that is based on multiple frame time periods. For example, where communication latency allows for two-picture based data repetition operations, the video transmitter 100 may allocate 600 bits for encoding the repeat slice within the two-picture, which may then be transmitted as separate 300 bit portions corresponding to each of the two pictures. The video transmitter 100 may also be operable to selectively allocate bits for encoding the repeat and non-repeats slices in a manner that may not necessarily be proportional to the proportion of the slices within given pictures. For example, the video transmitter 100 may determine that it may be more desirable to enhance the quality of the non-repeat slice encoding, by reducing the compression ratio, which may be achieved by allocating more bits to encoding the non-repeat slices for example. Accordingly, in the previous example, each non-repeat slice may be allocated 350 bits within each picture time in the two-picture time, while the repeat slice may be allocated 150 bits within each picture time in the two-picture time.

The video receiver 150 may be operable to handle adaptively generated compressed bitstreams. In this regard, the video receiver 150 may be operable to parse the received compressed bitstream to separate data encoded therein in accordance with corresponding pictures and/or portions thereof. The video receiver 150 may determine, for example, when pictures, and/or portions therein, are allocated additional bits beyond what normally is allocated based solely on maximum available bit rate in the communication medium 130 and/or proportion of various portions in given pictures. Accordingly, the video receiver 150 may determine when sufficient data has been received to generate a given decoded picture, and/or portions therein, within the sequence of decoded pictures. For example, the receiver may determine that decoding of a picture, or one repeat slice of a picture, had been completed when all the pixels within the picture or the repeat slice are decoded. If sufficient data to generate a given decoded picture, or slice therein, is not received within a frame time period, the video receiver 150 may display, or enable to be displayed, a previous decoded picture, or a previous collocated slice. The previous decoded picture may be stored in a non-transitory computer readable medium, such as random access memory, for example.

Because of the variable bit allocation among and/or within pictures, information may be incorporated into the compressed bitstream to enable correlating the data in the compressed bitstream with particular pictures in the sequence, and/or portions thereof. In various embodiments of the invention, the compressed bitstream may incorporate information which indicate, for example, whether data for the compressed bitstream, which corresponds to the repeat slice, is based on data repetition that are detected among the repeat slices in the sequence of pictures. In response, the video receiver 150 may determine whether sufficient data has been received to generate a decoded repeat slice. When sufficient data has not been received, the video receiver 150 may display a current received decoded non-repeat slice and a previously decoded repeat slice. When sufficient data has been received, the video receiver 150 may display the current decoded non-repeat slice and the current decoded repeat slice. The compressed bitstream may incorporate information which may indicate whether data for the compressed bitstream, which corresponds to the non-repeat slices, is based on the available bandwidth in the communication medium 130 and based on data repetition that are detected among the repeat slices in the sequence of pictures. In response, the video receiver 150 may determine whether the current received data corresponds to a non-repeat slice. When the current received data does not correspond to a non-repeat slice, for example when the current received data corresponds to a picture, the video receiver 150 may display the current decoded picture.

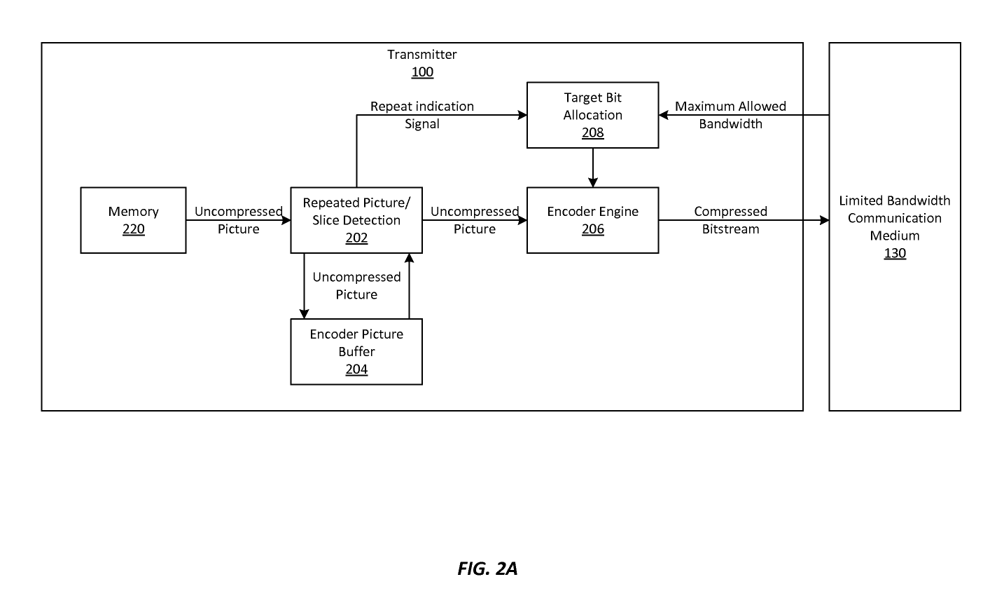

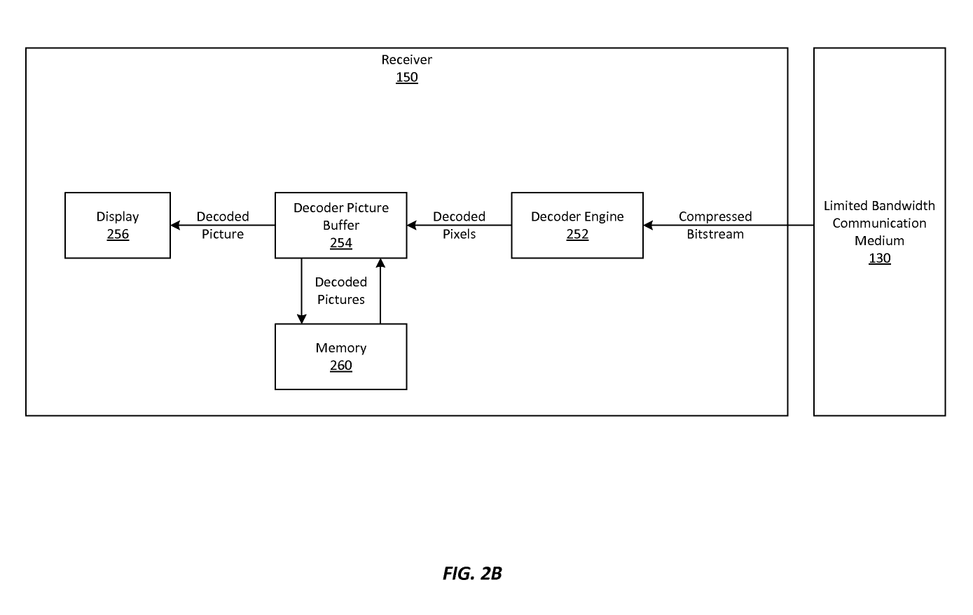

FIG. 2A is a block chart that illustrates an exemplary transmitting device for repetition based adaptive video compression, in accordance with an embodiment of the invention. Referring to FIG. 2A, there is shown the video transmitter 100 and the communication medium 130 of FIG. 1. The video transmitter 100 may comprise a repeated picture/repeat slice detection block 202, an encoder picture buffer 204, an encoder engine 206, a target bit allocation block 208 and a memory 220. The repeated picture/repeat slice detection block 202, encoder picture buffer 204, encoder engine 206, target bit allocation block 208 and memory 220 may each comprise suitable logic, circuitry, interfaces, and/or code, which enable the operations and/or functionality described herein.

The memory 220 may comprise suitable circuitry logic, and/or interfaces that may be utilized to store data for one or more uncompressed pictures. The memory 220 may comprise a non-transitory computer readable medium, which may be implemented utilizing various memory technologies, including various types of random access memory (RAM), read only memory (ROM), FLASH memory and/or disk-based memory, which may include both optical and magnetic storage media.

In operation, the repeated picture/repeat slice detection block 202 may comprise suitable circuitry, logic, interfaces and/or code that may be operable to receive uncompressed picture data for a current picture from memory 220. The repeated picture/repeat slice detection block 202 may store the uncompressed picture data for the current picture in the encoder picture buffer 204. The repeated picture/repeat slice detection block 202 may also communicate the current picture to the encoder engine 206. The repeated picture/repeat slice detection block 202 may retrieve uncompressed picture data for a previous picture from encoder picture buffer 204. The repeated picture/repeat slice detection block 202 may detect whether the current picture and the previous picture comprise repeated data and/or whether a repeat slice within the current picture and a repeat slice within the previous picture comprise repeated data. In an exemplary embodiment of the invention, the repeated picture/repeat slice detection block 202 may detect repeated data by performing a pixel by pixel sum of absolute difference (SAD) computation between each pixel in the current picture and each pixel in the previous picture. The resulting SAD value may be compared to a programmable threshold value. A repeated picture or repeat slice may be determined in instances where the SAD value is not greater than the threshold value. The repeated picture/repeat slice detection block 202 may increment, or enable to be incremented, a repetition count value for each detected picture or repeat slice among a sequence of pictures. Based on the repetition count value, the repeated picture/repeat slice detection block 202 may generate a repeat signal.

The encoder picture buffer 204 may comprise suitable circuitry, logic, and/or interfaces that may be utilized to store data for one or more uncompressed pictures. The encoder picture buffer 204 may comprise a non-transitory computer readable medium, which may be implemented utilizing various memory technologies, including various types of random access memory (RAM) and/or FLASH memory.

The target bit allocation block 208 may comprise suitable circuitry, logic, interfaces and/or code that may be operable to receive maximum allowed bandwidth information and a repeat signal. The maximum allowed bandwidth information may indicate the available bandwidth for signal transmission via the communication medium 130. The target bit allocation block 208 may receive the maximum allowed bandwidth information based on configuration information for the video transmitter 100, via feedback information received via the communication medium 130 and/or via signals received via the communication medium 130. The repeat signal may be received from the repeated picture/repeat slice detection block 202. The maximum allowed bandwidth information may indicate a maximum data rate, as measured in bits/second for example, for signals transmitted via the communication medium 130. Based on the repeat signal and the maximum allowed bandwidth information, the target bit allocation block 208 may determine the number of bits, which may be allocated for encoding the current picture. The target bit allocation block 208 may communicate the target bit allocation to encoder engine 206.

The encoder engine 206 may comprise suitable circuitry, logic, interfaces and/or code receive uncompressed picture data for a current picture from the repeated picture/repeat sliced detection block 202 and bit allocation target information from the target bit allocation block 208. Based on these inputs, encoder engine 206 may utilize various video compression algorithms to encode the uncompressed picture data for the current picture. Based on the encoding, encoder engine 206 may generate a compressed bitstream. In various embodiments of the invention, the bit rate for the compressed bitstream may be adaptively determined based on the maximum allowed bandwidth for the communication channel 130 and based on the repetition count value. Video transmitter 100 may transmit the compressed bitstream via the communication medium 130.

FIG. 2B is a block chart that illustrates an exemplary receiver device for repetition based adaptive video compression, in accordance with an embodiment of the invention. Referring to FIG. 2B, there is shown the video receiver 150 and the communication medium 130 of FIG. 1. The video receiver 150 may comprise a decoder engine 252, a decoder picture buffer 254, a display 256 and a memory 260. The decoder engine 252, decoder picture buffer 254, display 256 and memory 260 may each comprise suitable logic, circuitry, interfaces, and/or code, which enable the operations and/or functionality described herein.

The memory 260 may comprise suitable circuitry, logic, and/or interfaces that may be utilized to store data for one or more uncompressed pictures. The memory 260 may comprise a non-transitory computer readable medium, which may be implemented utilizing various memory technologies, including various types of random access memory (RAM), read only memory (ROM), FLASH memory and/or disk-based memory, which may include both optical and magnetic storage media.

The engine 252 may comprise suitable circuitry, logic, interfaces and/or code that may be operable to receive a compressed bitstream via the communication medium 130. The compressed bitstream may comprise header information, for example, which enables decoder engine 252 to decode the received compressed bitstream. The decoder engine 252 may utilize various video compression algorithms to decode the compressed picture data to generate decoded pixels. Based on information contained within the received compressed bitstream, the decoder engine 252 may map each decoded pixel to a location within a decoded picture.

The decoder picture buffer 254 may comprise suitable circuitry, logic, interfaces and/or code that may be utilized to store data for one or more uncompressed pictures. The decoder picture buffer 254 may comprise a non-transitory computer readable medium, which may be implemented utilizing various memory technologies, including various types of random access memory (RAM) and/or FLASH memory.

The display 256 may comprise suitable circuitry, logic, interfaces and/or code that may be utilized to provide an audio and/or visual representation of decoded picture data. The display 256 may comprise a visual presentation device, such as a television screen and/or an audio presentation device, such as audio speakers. The display 256 may provide visual rending of decoded picture data in color and/or black and white images. The display 256 may provide visual rendering of decoded picture data in still and/or motion pictures. The display 256 may map pixel data in the decoded picture data to locations on the display.

In operation, the decoder engine 252 may receive a compressed bitstream via the communication medium 130. The decoder engine 252 may decode the received compressed bitstream to generate a sequence of decoded pixels. The decoder picture buffer 254 may receive the sequence of decoded pixels. The decoder picture buffer 254 may utilize identifying data within the received compressed bitstream to map each decoded pixel to a location within a current decoded picture. The decoder picture buffer 254 may utilize the identifying data within the received compressed bitstream to determine when a sufficient number of decoded pixels has been received to generate a given decoded picture within the sequence of decoded pictures. If sufficient data to generate a given decoded picture is not received within a frame time period, the decoder picture buffer 254 may display, or enable to be displayed, a previous decoded picture, via a display device, for example. In an exemplary embodiment of the invention, the previous decoded picture may be stored in memory 260. The decoder picture buffer 254 may retrieve the previous decoded picture from the memory 260 and send the retrieved previous decoded picture to display 256.

In various embodiments of the invention, the decoder picture buffer 254 may utilize identifying data within the received compressed bitstream to determine whether the locations of received decoded pixels correspond to a repeat slice. In response, the decoder picture buffer 254 may determine whether a sufficient number of decoded pixels have been received to generate a decoded repeat slice. When a sufficient number of decoded pixels have not been received, the decoder picture buffer 254 may display a current received decoded non-repeat slice and a previously decoded repeat slice. When a sufficient number of decoded pixels have been received, the decoder picture buffer 254 may display the current decoded non-repeat slice and the current decoded repeat slice. The current received decoded non-repeat slice may correspond to decoded pixels received within a current frame time period. The current received decoded repeat slice may correspond to decoded pixels received within the current frame time period. The previously decoded repeat slice may correspond to decoded pixels received within a previous frame time period. The data for the decoded non-repeat slice and/or previously decoded repeat slice may be retrieved from the decoded picture buffer 254 and/or the memory 260.

In various embodiments of the invention, the decoder picture buffer 254 may utilize identifying data within the received compressed bitstream to determine whether the locations of received decoded pixels correspond to a non-repeat slice. In response, the decoder picture buffer 254 may determine whether a sufficient number of decoded pixels have been received to generate a non-repeat slice. When a sufficient number of decoded pixels have not been received, the decoder picture buffer 254 may display a current received decoded non-repeat slice and a previously decoded repeat slice. When a sufficient number of decoded pixels have been received to generate a current decoded picture, the decoder picture buffer 254 may display the current decoded non-repeat slice and the current decoded repeat slice. The current decoded picture may correspond to decoded pixels received within a current frame time period. The current decoded picture may comprise a current decoded non-repeat slice and a current decoded repeat slice.

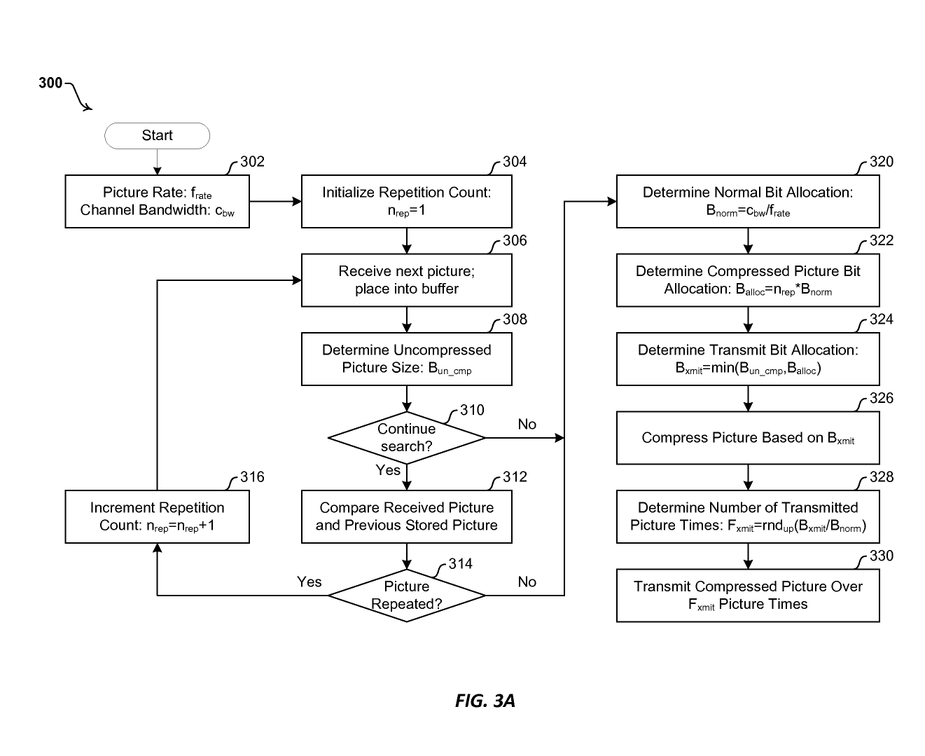

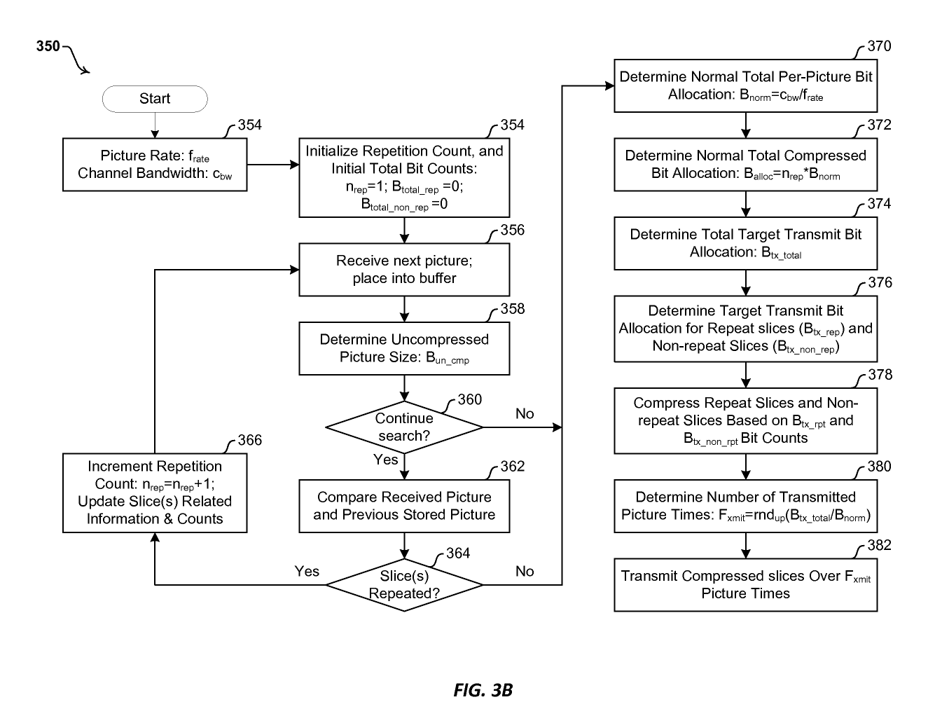

FIG. 3A is a flow chart that illustrates exemplary steps for adaptive video compression based on picture repetition during video transmission, in accordance with an embodiment of the invention. Referring to FIG. 3A, there is shown a plurality of exemplary steps 300 that may be performed by, for example, the video transmitter 100 to enable performing video compression based on repetition of full picture in sequence of uncompressed pictures. In this regard, a video picture may be adaptively compressed based on the number of detected repetitions of the video picture among a sequence of video pictures.

In step 302, a picture rate for sequence of pictures, fᵣₐₜₑ, for sequence of pictures and a channel bandwidth, c_{bw}, corresponding to channel that may be utilized in transmitting the sequence, such as via the communication medium 130, may be determined. The picture rate may correspond to the frame time period and the channel bandwidth may correspond to the maximum allowed bandwidth for communication medium 130. The picture rate may be determined based on configuration information and/or based on an applicable industry standards document. The channel bandwidth may be determined based on configuration information, feedback information and/or received signals. In step 304, a repetition count value, nᵣₑₚ, may be initialized to a value nᵣₑₚ=1. In this regard, the repetition count may indicate the number of times a given picture is repeated within a search window in the sequence. The search window may comprise a number of pictures in the sequence that may be searched for repetition data. In this regard, size of the search window, corresponding to the number of pictures in the search window for example, may be determined based on various predetermined and/or configurable criteria. For example, the size of the search window may be determined based on latency related information. In this regard, user input may limit, for example, acceptable latency during video transmission, measured in frame time delays for example, dictating that the size of the search window would be limited to a fixed number of pictures, such as two consecutive pictures for example.

In step 306, a picture may be received, and may be placed into a buffer. In this regard, the received picture may correspond to uncompressed picture that may be retrieved from memory 220 by the repeated picture/slice detection block 202 for example. In step 308, an uncompressed picture size, Bᵤₙ_{_{—}}_{cmp}, may be determined for the received picture. The uncompressed picture size may be determined based on the number, and/or arrangement, of pixels in the received picture. In step 310, a determination whether to continue with data repetition search may be performed. In this regard, search continuation determination may be based on, for example, comparing current value of nᵣₑₚ with size of the search window. In instances where it may be determination that the repetition search may not continue, the plurality of exemplary steps may skip to step 320. Otherwise, the plurality of exemplary steps may continue to step 312.

In step 312, the repeated picture/slice detection block 202 may compare the received picture and a previous stored picture for full picture repetition, substantially as described with regard to FIGS. 1 and 2A for example. In step 314, the repeated picture/slice detection block 202 may determine whether the current received picture is a repeated picture of the previous stored picture. The repeated picture/slice detection block 202 may determine whether a picture is repeated based on a SAD computation. In instances where the repeated picture/slice detection block 202 detects a repeated picture, the plurality of exemplary steps may proceed to step 316. In step 316, the repetition count may be incremented to a value nᵣₑₚ=nᵣₑₚ+1. The plurality of exemplary steps may then return to step 306, to enable receiving a following picture.

Returning to step 314, in instances where the repeated picture/slice detection block 202 does not detect a repeated picture, the plurality of exemplary steps may proceed to step 320. In step 320, the repeated picture/slice detection block 202 may generate a repeat signal based on the current value of the repetition count, nᵣₑₚ. Based on the repetition count and the channel bandwidth, target bit allocation block 208 may determine a normal bit allocation, Bₙₒᵣₘ. The normal bit allocation may be utilized to determine the maximum number of bits that may be utilized in generating compressed data corresponding to the current received uncompressed picture, which may be transmitted via the communication medium 130 within a single frame time period. In an exemplary embodiment of the invention, the bit allocation may be determined as shown in the following equation:

$${B}_{norm} = \frac{{c}_{bq}}{{f}_{rate}} \qquad [ 1 ]$$

In step 322, the encoder engine 206 may determine a bit allocation, B_{alloc}, for generating a compressed picture representation of the current received picture. In this regard, the compression bit allocation may be determined based on normal bit allocation, Bₙₒᵣₘ, and the repetition count value nᵣₑₚ as shown in the following equation:

B_{alloc}=nᵣₑₚ*Bₙₒᵣₘ [2]

In this regard, in accordance with equation [2], as a picture is increasingly repeated across a sequence of pictures, encoder engine 206 may increase the number of bits that may be utilized for generating a compressed picture representation of the uncompressed picture, which may enable reducing the compression ratio. However, the encoder engine 206 may not generate a compressed picture representation of the uncompressed picture, wherein the compressed picture representation comprises a larger number of bits than are present in the uncompressed picture. Accordingly, in step 324, the encoder engine 206 may determine a transmit bit allocation, Bₓₘᵢₜ, which correspond to the actual number of bits that may be utilized in generating the compressed picture representation of the uncompressed picture. In this regard, the transmit bit allocation represents the minimum of the values Bᵤₙ_{_{—}}_{cmp} and B_{alloc} as shown in the following equation:

Bₓₘᵢₜ=min(Bᵤₙ_{_{—}}_{cmp},B_{alloc}) [3]

In step 322, the encoder engine 206 may generate a compressed picture representation of the current received uncompressed picture for the compressed bitstream, wherein the number of bits transmitted in the compressed bitstream may be determined based on the transmit bit allocation value, Bₓₘᵢₜ. In step 324, the encoder engine 206 may determine the number of frame time periods may be required to transmit the bits in the compressed picture representation via communication medium 130. The number of frame time periods, Fₓₘᵢₜ, may be determined as shown in the following equation:

$${F}_{xmit} = {rnd}_{up} ( \frac{{B}_{xmit}}{{B}_{norm}} ) \qquad [ 4 ]$$

where rndᵤₚ( ) may be a rounding-up function. In this regard, rndᵤₚ(x) may set the output to x when x is an integer and int(x) when x is not an integer, where int(x) is the integer portion of x. In step 326, transmitter 100 may transmit the compressed picture representation over Fₓₘᵢₜ frame time periods.

FIG. 3B is a flow chart that illustrates exemplary steps for adaptive video compression based on slice repetition during video transmission, in accordance with an embodiment of the invention. Referring to FIG. 3B, there is shown a plurality of exemplary steps 350 that may be performed by, for example, the video transmitter 100 to enable performing video compression based on repetition of portions (slices) with pictures in sequence of uncompressed pictures. In this regard, a video picture may be adaptively compressed based on the number of detected repetitions of the video picture among a sequence of video pictures. Furthermore, while FIGS. 3A and 3B describe perform adaptive video compression separately based on full pictures and slices of pictures, respectively, the invention need not be so limited. In this regard, in various embodiments of the invention, adaptive video compression may be performed based on one or both of full picture repetition and slice repetition.

In step 352, a picture rate for sequence of pictures, fᵣₐₜₑ, for sequence of pictures and a channel bandwidth, c_{bw}, corresponding to channel that may be utilized in transmitting the sequence, may be determined, substantially as described with regard to step 302 of FIG. 1A. In step 354, a repetition count value, nᵣₑₚ, may be initialized to a value nᵣₑₚ=1; and total bit counts Bₜₒₜₐₗ_{_{—}}ᵣₑₚ and Bₜₒₜₐₗ_{_{—}}ₙₒₙ_{_{—}}ᵣₑₚ may each be initialized to 0. In this regard, the repetition count nᵣₑₚ may indicate the number of pictures in the sequence that may comprise at least a particular repeated slice, within a search window in the sequence. The total bit counts Bₜₒₜₐₗ_{_{—}}ᵣₑₚ and Bₜₒₜₐₗ_{_{—}}ₙₒₙ_{_{—}}ᵣₑₚ may indicate total bit counts corresponding to repeated and non-repeated video data, respectively, in the sequence that may comprise the particular repeated slice(s), within the search window. The search window may comprise a number of pictures in the sequence that may be searched for repetition data. In this regard, size of the search window, corresponding to the number of pictures in the search window for example, may be determined based on various predetermined and/or configurable criteria. For example, the size of the search window may be determined based on latency related information. In this regard, user input may limit, for example, acceptable latency during video transmission, measured in frame time delays for example, dictating that the size of the search window would be limited to a fixed number of pictures, such as two consecutive pictures for example.

In step 356, a picture may be received, and may be placed into a buffer. In this regard, the received picture may correspond to uncompressed picture that may be retrieved from memory 220 by the repeated picture/slice detection block 202 for example. In step 358, an uncompressed picture size, Bᵤₙ_{_{—}}_{cmp}, may be determined for the received picture. The uncompressed picture size may be determined based on the number, and/or arrangement, of pixels in the received picture. Furthermore, each of the Bᵤₙ_{_{—}}_{cmp} values corresponding for each of received pictures within the search window may stored for subsequent use, such as for controlling and/or adjusting bit allocation during compression of video data corresponding to the current picture, to ensure that total compression bit allocation count does not exceed the Bᵤₙ_{_{—}}_{cmp} value for example. In step 360, a determination whether to continue with data repetition search may be performed. In this regard, search continuation determination may be based on, for example, comparing current value of nᵣₑₚ with size of the search window. In instances where it may be determination that the repetition search may not continue, the plurality of exemplary steps may skip to step 370. Otherwise, the plurality of exemplary steps may continue to step 362.

In step 362, the repeated picture/slice detection block 202 may compare the received picture and a previous stored picture for slice repetition, substantially as described with regard to FIGS. 1 and 2A for example. In step 364, the repeated picture/slice detection block 202 may determine whether the current received picture comprises the particular slice that may be a repeat of a slice in the previous stored picture. The repeated picture/slice detection block 202 may detect and/or determine slice repetition based on SAD computations. In instances where the repeated picture/slice detection block 202 detects at least one repeated slice, the plurality of exemplary steps may proceed to step 366. In step 366, the repetition count may be incremented to a value nᵣₑₚ=nᵣₑₚ+1. Furthermore, information relating to detected repeat and/or non-repeat slices may be generated and/or modified. This may comprise generating and/or modifying information describing repeated slices and non-repeat slices within the current picture, to enable for example, spatially locating the slices within the current picture. Furthermore, current bit counts B_{cur}_{_{—}}ᵣₑₚ and B_{cur}_{_{—}}ₙₒₙ_{_{—}}ᵣₑₚ, which may indicate bit count corresponding to repeated and non-repeated video data, respectively, in the current uncompressed picture, may be determined. The current bit counts B_{cur}_{_{—}}ᵣₑₚ and B_{cur}_{_{—}}ₙₒₙ_{_{—}}ᵣₑₚ may also be utilized to modify and/or updated the total bit counts Bₜₒₜₐₗ_{_{—}}ᵣₑₚ and Bₜₒₜₐₗ_{_{—}}ₙₒₙ_{_{—}}ᵣₑₚ, respectively. In this regard, the repeat data bit count Bₜₒₜₐₗ_{_{—}}ᵣₑₚ may only be increased after the first time a particular repeated slice is detected, based on corresponding repeat data count, but may remain subsequently unchanged thereafter when detecting a slice in subsequent picture comprising the same repeated data. In addition, bit counts B_{cur}_{_{—}}ᵣₑₚ and B_{cur}_{_{—}}ₙₒₙ_{_{—}}ᵣₑₚ corresponding to each of received pictures within the search window may be stored for subsequent use, such as for controlling and/or adjusting total and/or per picture bit allocation during compression of repeat and/or non-repeat slices for example, to ensure that compression bit allocation to the repeat and non-repeat slices remains within applicable limits that may be determined based on total or per-picture bit counts B_{cur}_{_{—}}ᵣₑₚ and B_{cur}_{_{—}}ₙₒₙ_{_{—}}ᵣₑₚ values for example. The plurality of exemplary steps may then return to step 356, to enable receiving a following picture.

Returning to step 364, in instances where the repeated picture/slice detection block 202 does not detect a repeated slice, the plurality of exemplary steps may proceed to step 370. In step 370, the repeated picture/slice detection block 202 may generate a repeat signal based on the current value of the repetition count, nᵣₑₚ. Based on the repetition count and the channel bandwidth, target bit allocation block 208 may determine a normal per-picture bit allocation, Bₙₒᵣₘ. In this regard, the normal per-picture bit allocation Bₙₒᵣₘ may determine the maximum number of bits that may be utilized to generate compressed data corresponding to an uncompressed picture within a single frame time period. The normal bit allocation may be determined based on equation [1], substantially as described with regard to FIG. 3A. The target bit allocation block 208 may also determine normal per-picture slice bit allocation counts B_{norm rep} and Bₙₒᵣₘ_{_{—}}ₙₒₙ_{_{—}}ᵣₑₚ, which may indicate normal compression bit allocation for repeated and non-repeated data portions in each picture. In this regard, the normal per-picture slice bit allocation counts B_{norm rep} and Bₙₒᵣₘ_{_{—}}ₙₒₙ_{_{—}}ᵣₑₚ may be determined as shown in the following equations:

$$\begin{matrix}{B}_{norm\_rep} = {B}_{norm} * ( \frac{repeat\_data \_size}{picture\_size} ) & [ 5 ] \\ {B}_{norm\_non \_rep} = {B}_{norm} - {B}_{norm\_rep} & [ 6 ]\end{matrix}$$

In step 372, the encoder engine 206 may determine a normal total compression bit allocation, B_{alloc}, which may be utilized in generating compressed picture representation of the currently buffered pictures comprising repeated slice(s). In this regard, the normal total compression bit allocation B_{alloc} may be determined based on normal per-picture bit allocation, Bₙₒᵣₘ, and the repetition count value nᵣₑₚ, using, for example, equation [2], substantially as described with regard to FIG. 3A. In accordance with equation [2], as a particular slice is increasingly repeated across multiple pictures in the sequence of pictures, the encoder engine 206 may combine bits that may otherwise be assigned for encoding the same slice in each of these pictures, and may adaptively allocate these bits to encoding the repeat and non-repeat slices. The encoder engine 206 may not, however, generate compressed picture representation of any uncompressed pictures with number of bits that is larger than what is present in the uncompressed pictures, as measured by corresponding Bᵤₙ_{_{—}}_{cmp} values for example. Accordingly, in step 374, the encoder engine 206 may determine a transmit bit allocation, Bₜₓ_{_{—}}ₜₒₜₐₗ, which may correspond to the actual number of bits that may be utilized in generating the compressed picture representation of the uncompressed picture(s). In this regard, the total bit counts Bₜₒₜₐₗ_{_{—}}ᵣₑₚ and Bₜₒₜₐₗ_{_{—}}ₙₒₙ_{_{—}}ᵣₑₚ may be utilized, for example, to ensure that total target compression bit allocation for repeated and non-repeated data, respectively, does not exceed corresponding uncompressed bit counts. The total transmit bit allocation may represent, for example, the minimum of the value B_{alloc} and a value representing the total of uncompressed repeat and non-repeat data, as shown in the following equations:

Bᵤₙ_{_{—}}_{cmp}=Bₜₒₜₐₗ_{_{—}}ₙₒₙ_{_{—}}ᵣₑₚ+Bₜₒₜₐₗ_{_{—}}ᵣₑₚ [7]

Bₜₓ_{_{—}}ₜₒₜₐₗ=min(Bᵤₙ_{_{—}}_{cmp},B_{alloc}) [8]

In step 376, the target bit allocation block 208 may determine target bit allocation counts Bₜₓ_{_{—}}ᵣₑₚ and Bₜₓ_{_{—}}ₙₒₙ_{_{—}}ᵣₑₚ, which may correspond to total bits that may be utilized in compressing repeat slices and non-repeat slices, respectively, within the group of picture that comprise at least one repeated slice. In this regard, the target bit allocation counts Bₜₓ_{_{—}}ᵣₑₚ and Bₜₓ_{_{—}}ₙₒₙ_{_{—}}ᵣₑₚ may determined such that for each picture in the group, non-repeat slices may be allocated a number of bits in each frame time that may be proportional to ratio of non-repeat bits in the corresponding uncompressed picture. Alternatively, Bₜₓ_{_{—}}ᵣₑₚ and Bₜₓ_{_{—}}ₙₒₙ_{_{—}}ᵣₑₚ may determined such that non-repeat slices, which may typically comprise portion with moving data, may be allocated a number of bits in each frame time that may be greater than ratio of non-repeat bits in the corresponding uncompressed picture because compression of the same repeated slice may be spread over the group of pictures with repeated data and/or may be compressed in only some of the frames and reused for the remaining frames. Furthermore, total bit counts Bₜₒₜₐₗ_{_{—}}ᵣₑₚ and Bₜₒₜₐₗ_{_{—}}ₙₒₙ_{_{—}}ᵣₑₚ and/or per-pictures uncompress bit counts B_{cur}_{_{—}}ᵣₑₚ and B_{cur}_{_{—}}ₙₒₙ_{_{—}}ᵣₑₚ may be utilized to ensure that the amount of bits allocated for the compression does not exceed, for any particular slice, the amount of the bits of the corresponding uncompressed video data.

In step 378, the encoder engine 206 may generate a compressed picture representation of the current received uncompressed picture for the compressed bitstream, wherein the number of bits transmitted in the compressed bitstream may be determined based on the transmit bit allocation value, Bₜₓ_{_{—}}ₜₒₜₐₗ. In step 380, the encoder engine 206 may determine the number of frame time periods may be required to transmit the bits in the compressed picture representation via communication medium 130. The number of frame time periods, Fₜₓ_{_{—}}ₜₒₜₐₗ, may be determined as shown in the following equation:

$${F}_{xmit} = {rnd}_{up} ( \frac{{B}_{tx\_total}}{{B}_{norm}} ) \qquad [ 9 ]$$

where rndᵤₚ(x) may set the output to x when x is an integer, or to the integer portion of x when x is not an integer. In step 382, transmitter 100 may transmit the compressed picture representation over Fₜₓ_{_{—}}ₜₒₜₐₗ frame time periods.

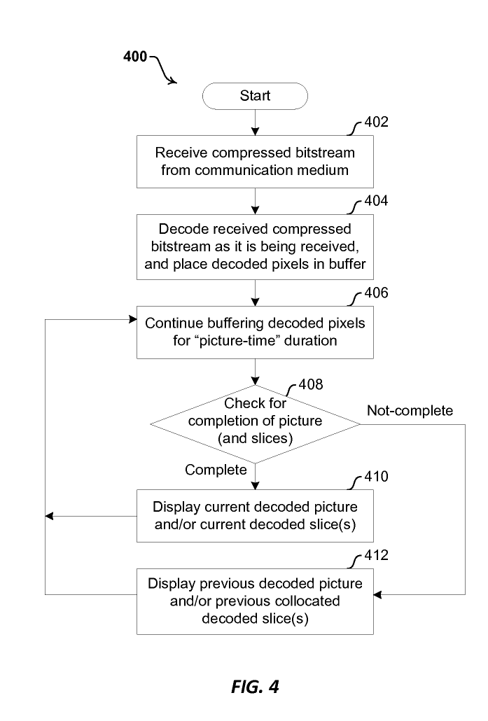

FIG. 4 is a flow chart that illustrates exemplary steps for receiving video data that may be compressed adaptively based on repetition, in accordance with an embodiment of the invention. Referring to FIG. 4, there is shown a plurality of exemplary steps 400 that may be performed by, for example, the video receiver 150 to enable receiving compressed bitstream comprising video data corresponding to a sequence of pictures, wherein the compressed bitstream may have been generated utilizing repetition based video compression. In this regard, one or more repeated pictures, or repeated slice, may be combined during the video encoding at the transmitter side to enable reducing the compression ratio, substantially as described with regard to FIGS. 3A and 3B for example.

In step 402, the receiver 150 may receive the compressed bitstream via communication medium 130. In step 404, the decoder engine 252 may decode the compressed bitstream as it is being received to generate a sequence of decoded pixels which may be encoded into the compressed bitstream. The decoded pixels may be stored into the decoder picture buffer 254, which may handle generating and/or assembling the corresponding original sequence of pictures for display, via the display 256 for example. After continuing, at step 406, to buffer decoded pixels for a delay time that may be configured to be equivalent to picture (or) frame time, the decoder picture buffer 254 may determine, at step 408, whether a sufficient number of decoded pixels have been received to generate a corresponding display picture. In this regard, the decoder picture buffer 254 may determine sufficiency of received pixels on per-picture and/or per-slice basis.

In instances where it is determined that a sufficient number of decoded pixels for generating a current display picture, or a current slice, have been received, the plurality of exemplary steps may proceed to step 410. In step 410, the decoder picture buffer 254 may enable display 256 to display a picture comprising the current received video data. In this regard, where the current sufficient data correspond to a full picture, the whole decoded picture may be sent to from the decoder picture buffer 254 to the display 256. Where the current video data only comprise a current slice, the decoder picture buffer 254 may generate a current display picture that may comprise the current slice. In this regard, the decoder picture buffer 254 may combine current slices and remaining slices, which may have been previously received, and which may be stored into and/or retrieved from the memory 260 for example. This may be done, for example, when the current video data correspond to the non-repeat slice in a picture that also comprise a repeat slice that may have been received in a proceeding picture (frame) time.

Returning to step 408, in instances where it is determined that a sufficient number of decoded pixels for generating a current display picture, or a current slice, have not been received, the plurality of exemplary steps may proceed to step 412. In step 412, the decoder picture buffer 254 may enable display 256 to display a picture comprising previously received video data, corresponding to full picture and/or slices therein, which may be stored into and/or retrieved from the memory 260 for example.

Aspects of a method and system for repetition based adaptive video compression may include a repeated picture/repeat slice detection block 202 that compares uncompressed picture data for a picture among a sequence of pictures with uncompressed picture data for one or more preceding pictures among the sequence of pictures. The repeated picture/repeat slice detection block 202 may determine a number of repeated pictures in the sequence of pictures. An encoder engine 206 may generate a compressed bit stream for the picture based on the determined number of repeated pictures and based on a channel bandwidth for a communication medium 130. A video transmitter 100 may transmit the compressed bit stream via the communication medium 130.

The repeated picture/repeat slice detection block 202 may compute a sum of differences value based on the comparison described above. The sum of differences value may be computed based on uncompressed picture data within a portion of the picture. The portion of the picture may be referred to as a repeat slice picture and a remainder of the picture, exclusive of the repeat slice, may be referred to as a non-repeat slice. The encoder engine 206 may generate a plurality of bits for the compressed bit stream based on the non-repeat slice, wherein the number of bits is based on the channel bandwidth.

The repeated picture/repeat slice detection block 202 may increment a repetition count value, which is utilized for determining the number of repeated pictures, when the sum of differences value is not greater than a threshold value.

A target bit allocation block 208 may determine a normal bit allocation based on the channel bandwidth. A compressed bit allocation may be determined based on the normal bit allocation and the determined number of repeated pictures. The encoder engine 206 may generate a plurality of bits for the compressed bit stream, wherein a number of the plurality of bits is based on the compressed bit allocation. The video transmitter 100 may transmit the plurality of bits via the communication medium 130 at a bit rate, wherein the bit rate is based on the channel bandwidth.

Another embodiment of the invention may provide a non-transitory computer readable medium, having stored thereon, a computer program having at least one code section executable by a computer, thereby causing the computer to perform the steps as described herein for repetition based adaptive video compression.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
detecting in a video transmitter presence of repeated data in a picture in a sequence of picture based on comparing of uncompressed picture data corresponding to said picture with at least one preceding picture in said sequence of pictures;
allocating based on said detection of presence of repeated data, a target bit count corresponding to said picture within a compressed bitstream that is utilized for communication of said sequence of pictures, wherein said allocation comprises determining at least a portion of said target bit count based on combining of encoding of said repeated data between said picture and said at least one proceeding picture in said sequence of picture; and
generating based on said allocated target bit count, compressed data corresponding to said picture for transmission as part of said compressed bitstream.

2. The method according to claim 1, wherein said repeated data correspond to only a portion of said uncompressed picture.

3. The method according to claim 1, comprising determining a normal per-picture bit count in said compressed bitstream corresponding to each of said sequence of pictures.

4. The method according to claim 3, comprising determining said normal per-picture bit count based on channel bandwidth associated with a communication medium utilized for said communication of said sequence of pictures.

5. The method according to claim 3, comprising determining said target bit count based on said normal per-picture bit count.

6. The method according to claim 1, comprising determining a number of proceeding pictures for performing said comparing of uncompressed picture data for said detection of presence of repeated data.

7. The method according to claim 6, comprising determining said number of proceeding pictures based on allowed latency for said communication of said sequence of pictures.

8. The method according to claim 1, comprising performing said comparing of uncompressed picture data based on differences in pixel values between each two pictures in said sequence of pictures.

9. The method according to claim 8, comprising computing a sum of said differences in pixels value.

10. The method according to claim 9, comprising comparing said sum of said differences in pixels value with a threshold value to determine presence of said repeated data.

11. A system, comprising:
one or more circuits for use in a video transmitter, said one or more circuits being operable to:
detect presence of repeated data in a picture in a sequence of picture based on comparing of uncompressed picture data corresponding to said picture with at least one preceding picture in said sequence of pictures;
allocate based on said detection of presence of repeated data, a target bit count corresponding to said picture within a compressed bitstream that is utilized for communication of said sequence of pictures, wherein said allocation comprises determining at least a portion of said target bit count based on combining of encoding of said repeated data between said picture and said at least one proceeding picture in said sequence of picture; and
generate based on said allocated target bit count, compressed data corresponding to said picture for transmission as part of said compressed bitstream.

12. The system according to claim 11, wherein said repeated data correspond to only a portion of said uncompressed picture.

13. The system according to claim 11, wherein said one or more circuits are operable to determine a normal per-picture bit count in said compressed bitstream corresponding to each of said sequence of pictures.

14. The system according to claim 13, wherein said one or more circuits are operable to determine said normal per-picture bit count based on channel bandwidth associated with a communication medium utilized for said communication of said sequence of pictures.

15. The system according to claim 13, wherein said one or more circuits are operable to determine said target bit count based on said normal per-picture bit count.

16. The system according to claim 11, comprising determining a number of proceeding pictures for performing said comparing of uncompressed picture data for said detection of presence of repeated data.

17. The system according to claim 16, wherein said one or more circuits are operable to determine said number of proceeding pictures based on allowed latency for said communication of said sequence of pictures.

18. The system according to claim 11, wherein said one or more circuits are operable to perform said comparing of uncompressed picture data based on differences in pixel values between each two pictures in said sequence of pictures.

19. The system according to claim 18, wherein said one or more circuits are operable to compute a sum of said differences in pixels value.

20. The system according to claim 19, wherein said one or more circuits are operable to compare said sum of said differences in pixels value with a threshold value to determine presence of said repeated data.
